(19) United States
(12) Patent Application Publication
(10) Pub. No.: US 2021/0331939 A1
(43) Pub. Date: Oct. 28, 2021

(54) WATER PURIFICATION MODULE

(71) Applicant: Manfred VÖLKER, Blankenbach (DE)

(72) Inventor: Manfred VÖLKER, Blankenbach (DE)

(21) Appl. No.: 17/233,683

(22) Filed: Apr. 19, 2021

(30) Foreign Application Priority Data
Apr. 28, 2020 (DE) 10 2020 111 555.5

(51) Int. Cl. C02F 1/00

(52) U.S. Cl. CPC C02F 1/003; C02F 2201/004; C02F 1/283; C02F 2201/006; C02F 2201/007

(57) ABSTRACT

The water purification module includes a tubular receiving container with a base member and a removable lid with through bores, through which liquid to be purified may be supplied at the top into the interior of the receiving container. The water purification module also includes a tubular filter insert, which is removably suspended within the inner wall of the receiving container and is sealed with respect to the inner wall of the receiving container by an annular seal, and at least one extraction opening for purified liquid, which extends through the wall of the receiving container and/or the base member.

### PRIORITY CLAIM

The subject application claims convention priority to German patent application No. 10 2020 111 555.5 filed Apr. 28, 2020.

### FIELD OF THE INVENTION

The present invention refers to a water purification module. The fields of use are provided for laboratory, pharmaceutical, drinking water and medical applications. The accommodation and use of very widely varying filter media, even e.g. for arsenic and nitrate, is possible, and is not limited only to filter materials which are not regenerable in situ.

### BACKGROUND

Very widely varying techniques are used in order e.g. to prepare ready-to-use ultrapure water for laboratory applications. The predominantly used methods are multistage pressure-filtration processes, such as reverse osmosis with subsequent filtration stages up to chemical exchange filtration, such as demineralisers and mixed bed resins and subsequent polisher resins.

When using multistage pressure filtration processes, few consumable supplies are generally used but the technology is maintenance intensive and downtime caused by breakdown results in high costs caused by the stopping of expensive downstream devices and working time.

Chemical exchange filtration with mixed bed resins and subsequent polisher resins is technically not problematical but results in relatively high usage costs.

These usage costs are explained on the one hand by the fact that replacement of the filter media in situ is problematic. The removal of the filter media from the receptacle can cause contamination of the clean regions with particles. Residual liquid runs out of the containers when they are opened. Equipment is required for emptying and refilling. A mobile service therefore performs the replacement by means of complex logistics.

The unsatisfactory efficiency caused by inadequate flow through the filter medium results in high consequential costs per litre of filtered ultrapure water.

As regards hygiene and quality, a simple but reliable separation of the primary and secondary filter sides is absolutely necessary. The absence of a possibility for determining the filtration quality (sample removal) is disadvantageous. Further disadvantages can also be the absence of dead space-free overflow of the liquid supply and the absence of a possibility for cleaning the filter receptacle.

### SUMMARY OF THE INVENTION

The object of this development is to devise a large volume filter container, e.g. for the accommodation of filter materials which are not regenerable in situ after use, such as mixed bed resins and filter carbon.

The filter materials are to be simple to replace, the filter construction is to enable the highest possible recovery of the filter materials and furthermore also to ensure as high hygiene requirements as possible as regards handling and absence of dead spaces.

Necessary improvements and the purpose and object of this invention are therefore the reliable, user-friendly and rapid exchange of filter media/material and/or also resin. A particular requirement is the separation of the primary and secondary sides of the filter medium.

The reduction of the exchange intervals (resin change by better resin utilisation) is associated with great significance in order to achieve as low as possible cost per litre filtrate.

In addition to a large field of use with different filter media, a favourable, good logistic system or storage system is necessary.

For the removal of samples, a removal technique is to be used which permits a reliable conduct of the liquid directly without air contact into the sample container, even with problematical liquids.

Filter changes should be possible without spillage or liquid overflowing or discharging from the filter housing to the greatest extent possible. The air introduced into the filter housing during the change is to be able to be eliminated in a simple manner.

Different filter inserts of the same design are to be differentiated in a good manner.

This object is solved efficiently in accordance with the invention if the focus for the production of ultrapure liquid is placed not only on the process but principally on the filter materials, which are not regenerable or only poorly in situ, used in water purification devices, their usage and structural design.

For this purpose, the filter materials are introduced into either disposable or reusable, completely filled, filter inserts. The filter inserts are most simply insertable into a tube-like water purification module, whereby a complete separation of the primary and secondary sides of the filter is ensured only by the position of the filter insert and its sealing with respect to the receiving container.

Due to the special egg-shaped openings, distributed over the inlet and outlet of the filter inserts, the liquid is so distributed in the filter materials that a maximum yield is ensured.

Both the supply and discharge of the liquid into, out of and through the water purification module ensure furthermore a uniform distribution of the liquid as free of dead spaces as possible.

A replacement of the filter inserts is possible without spillage and overflowing from the water purification module.

Further details and advantages are described in the figures shown below.

### BRIEF DESCRIPTION OF THE DRAWINGS

FIG. 1 are schematics of flow plan variants of a water purification module.

FIG. 2 are multiple views of the components of the water purification module.

FIG. 3 are multiple detailed views of the water purification module.

FIG. 4 are multiple detailed views of a module insert having a disposable design.

FIG. 5 are multiple detailed views of a module insert having a refillable design.

### DETAILED DESCRIPTION OF PREFERRED EMBODIMENTS

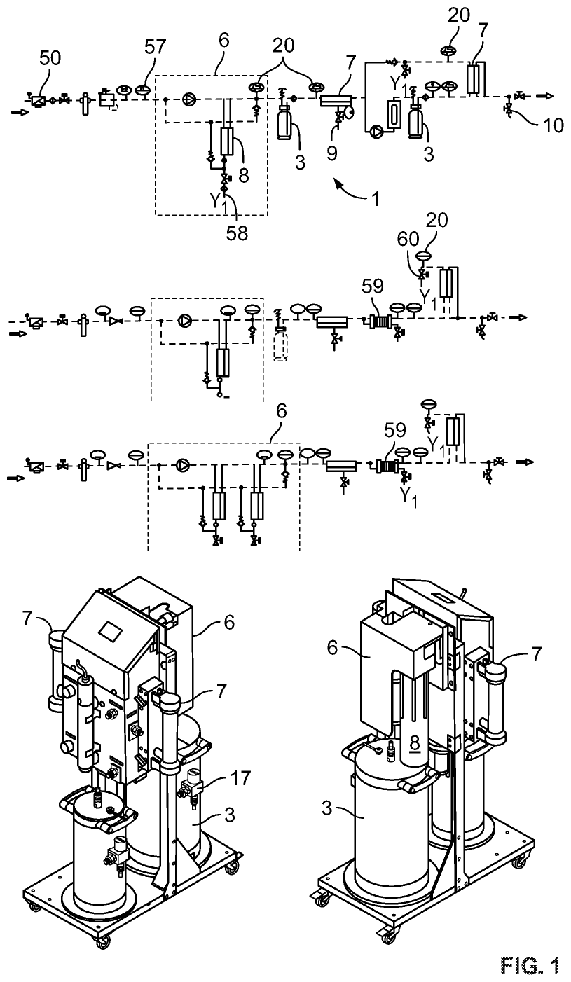

FIG. 1 shows a flow plan (1), which is connected at its inlet (50) to raw water via a backflow preventer. This raw water is processed by means of main components described below into a ready-to-use, ultrapure liquid and removed, for instance, as an intermediate product at the extraction point (9) or as a final product at the extraction point (10).

The raw water can be processed in a first stage by means of a reverse osmosis system (6) and/or by a water purification module, e.g. demineraliser (3) and removed at connection (9) by means of an ultrafilter/sterile filter as an intermediate product. For further purification, the liquid precleaned of chemical substances is cleaned of the remaining chemical substances by means of a further water purification module (3), e.g. filled with polisher resin, and conducted in microbiologically cleaned form to extraction point (10) via a sterile filter or ultrafilter.

In order to avoid stagnation, the liquid can be circulated by means of a pump and UV lamp both during an extraction process and also preferably in periods without extraction. It will be apparent that the important liquid parameters, such as temperature and conductivity, are monitored by means of sensors (20).

Further devices common in water purifiers, such as dry running protection, pressure reducers and prefiltration, pumps, flow meters and UV lamps are shown but not described in more detail. The flow meter (57) and other sensors are also usable at other metrologically relevant positions, such as for instance, at the drainage outlet (58).

FIG. 1 shows flow plan variants which demonstrate that e.g. one water purification module (3) could be omitted by the use of an EDI, electrode ionisation module (59), or both water purification modules (3) could be omitted by the use of a two-stage reverse osmosis system. The combination and variation of EDI (59), reverse osmosis system (6) and water purification module (3) enable the highest water quality and can reduce the replacement intervals of the same.

An exemplary construction of a process constructed to flow plan (1) is water purification device (2), shown in perspective in FIG. 1.

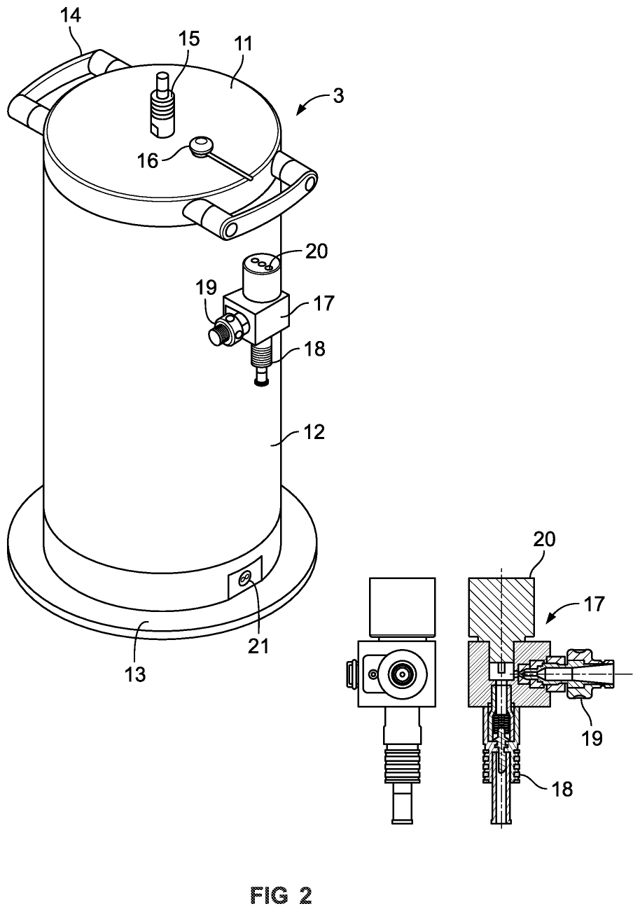

FIG. 2 shows the components, which are visible from the exterior, of the water purification module (3), comprising a cylindrical tube member (12), a base with plate (13) for standing on when opening the lid (11).

A functional block (17), e.g. for measuring conductivity and temperature and, if needed, flow (20), a sample extractor (19) and a connecting coupling (18) can optionally be attached laterally. The functional block (20) can include an indicator, e.g. in the form of a light and/or an acoustic signal emitter, which signals the usage condition of the filter media/material used and indicates a potential exchange.

A further extraction point (21) is optionally installed in the base portion (13). The handles (14), a connecting coupling (15) and a vent (16) complete the lid (11).

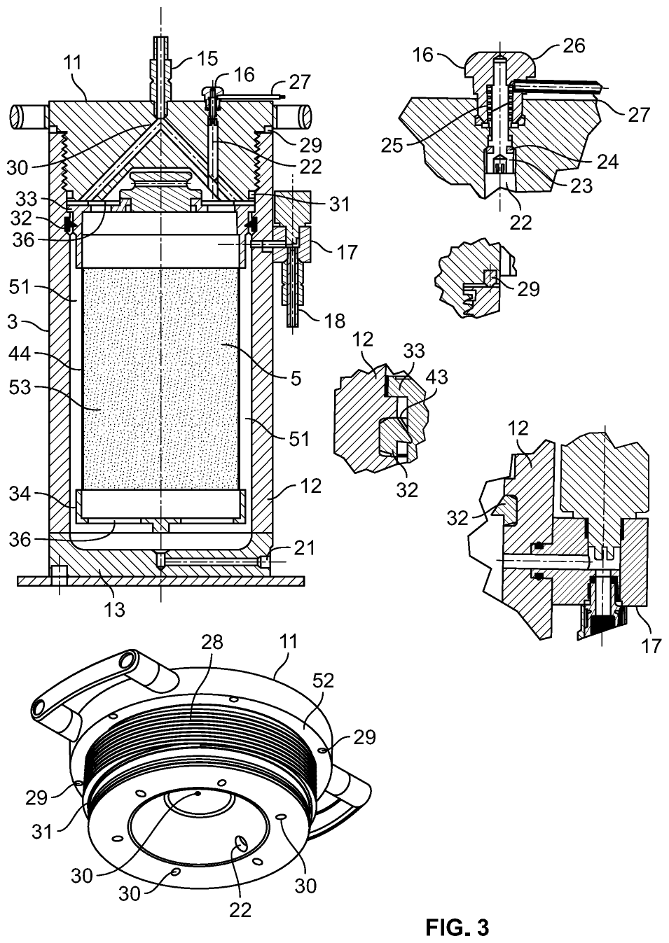

FIG. 3 shows the water purification module (3) in detail and in section.

The liquid advantageously flows via the connecting coupling (15) into the lid (11) and through the circular/obliquely arranged bores (30) situated in the lid and a bore situated in the centre of the lid to the lower edge of the lid. It flows from there via the circularly arranged, egg- or lancet-shaped filter flow openings (36) of the filter insert (4/5) through the filter material (53) and discharges at the lower filter holder (34) out of the circularly arranged, egg- or lancet-shaped filter flow openings (36) out of the filter insert (4/5) and flows out via annular gap (51) and functional block (17) and/or via connection (21). Connection (21) can be closed internally when not in use.

A reversal of the flow path is possible.

Seal (32) ensures a complete separation between the primary and secondary sides of the filter insert (4/5) by peripherally sealing against the sealing surface (43) of the upper filter holder (33). The sealing ring (32) is inserted into a groove in the tube (12). Sealing ring (32) is preferably constructed in the form of a lip seal. However, every other seal which is possible in this context may also be used and every other position of the sealing ring on the filter insert (4/5) is possible.

In order to support the tube wall (12) against deflection and to ensure the seal between the primary and secondary sides of the filter insert (4/5), an additional reinforcement of the tube wall (12) in the vicinity of the screw thread (28) and the seals (32/31) can be considered.

Air located in the interior of the filter insert (4/5) and on the upper side of the filter insert (4/5) can discharge out of the venting hose (27) via a vent bore (22) by pressing the vent button (26).

The venting hose (27) serves to conduct the air and the air-water mixture for hygienic reasons and the samples of liquid on the primary side.

The venting valve (16) closes automatically by means of spring (25) and seal (24). The venting passage (22) is opened by pressing the button (26). The vent button (26) is preferably constructed in a signal colour.

Lid (11) has a sawtooth-shaped screw thread (28), which engages in the corresponding screw thread on the tube (12). In order to ensure the seal of the lid (11), a sealing ring (31) is inserted into a peripheral groove in the lid (11). On the peripheral edge (52), the lid (11) has spherical protuberances (29) inserted, which ensure a spacing of the lid (11) from the upper edge of the tube (12) in order to prevent adhesion of the lid (11). Lid (11) projects deeply into the tube (12) in order to reduce the volume of liquid in the water purification module (3) to a minimum so that no liquid escapes when opening the lid (11) and removing the filter insert (4/5).

Instead of the screw thread (28), it is also common to use a bayonet closure, which is not illustrated here.

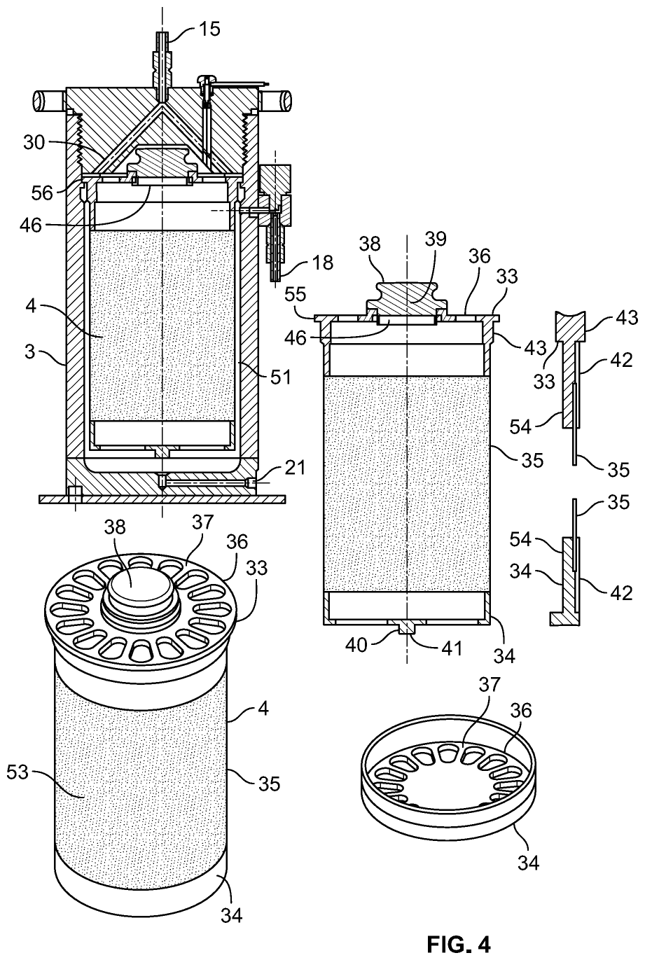

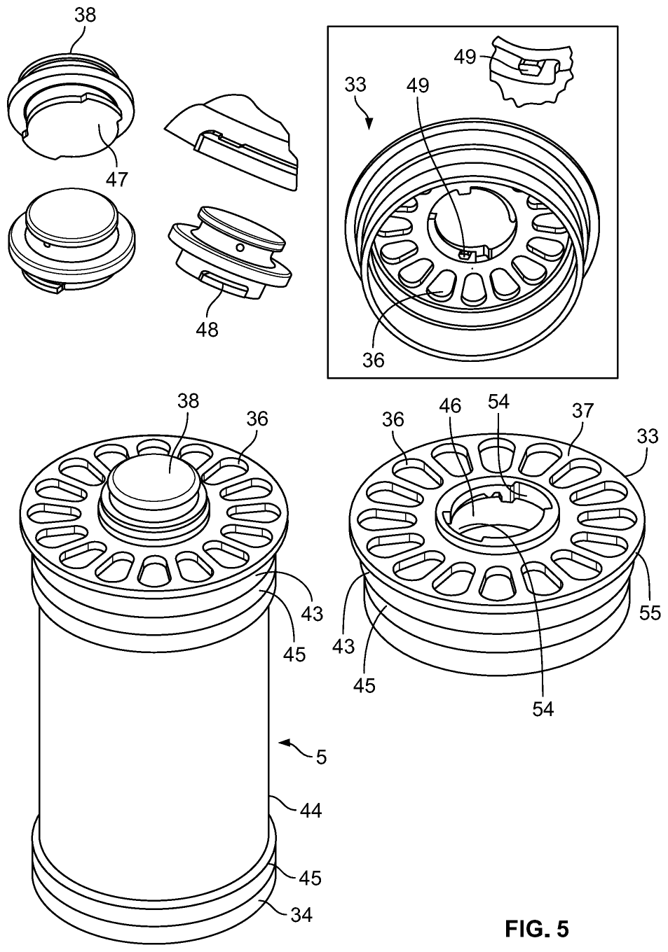

FIGS. 4 and 5 show module insert (4/5), wherein module insert (4) is usable as a disposable item and module insert (5) is reusable.

The module insert (4/5) is inserted into the container (3) with the lid (11) of the module (3) open. Module insert (4/5) rests on a ledge (56) on the tube (12) by means of a projection (55) on the filter holder (33).

A strap can be attached via bore (39) or in general to the filter holder (33) for the purpose of better handling of the module (4/5).

Module insert (4/5) consists of an upper filter holder (33) and a lower filter holder (34). The filter holders (33/34) are connected in module insert (4) with a film hose (35) and in module insert (5) with a hard, tubular cylinder.

The filter holder (33/34) itself is covered with a filter sieve (37) or with the webs, between the egg- or lancet-shaped flow openings (36), in order to hold the filter material (53) in the interior of the module inserts (4/5).

The mesh size of the filter sieve (37) is matched to the filter material (53).

FIG. 4 shows the filter insert (4) as a disposable design. For this purpose, a film hose (35) is pulled over small ledges (45) on the filter holders (33/34) and connected to the filter holders (33/34) over their entire periphery by means of adhesive band (42). The film hose (35) can also be fastened to the filter holder (33/43) by means of welding. In order to fill the module (4), the filling opening (46) is used, the filter material (53) introduced and is subsequently closed again by means of closure lid (38).

FIG. 5 shows the construction of the filter insert (5) as a refillable filter insert. For this purpose, there is the possibility, in addition to the film hose (35), of affixing a cylindrical hard-shelled material (44) to the filter holders (33/34).

The upper closure lid (38) can be inserted into two latching openings (54) via the opening (46) in the upper filter holder (33). Latches (47) engage with their latch detent (48) with a latch lug (49). Depending on the construction of the latch detent (48) and latch lug (49) there is the possibility of opening the closure lid or to construct it so that it can only be opened destructively.

In order to distinguish different filter inserts (4/5) filled with different filter materials or batches, the filter lid can be marked with a colour or in some other way. In order to empty the filter material (53), the filter inserts (4/5) can be suspended by means of suspension pegs (40), with the closure lid (38) open, and emptied.

It is stressed that the invention is not limited to the described and illustrated embodiments. On the contrary, all the features disclosed may be individually combined with one another in any sensible manner.

1. A water purification module comprising: a tubular receiving container with a base member and a removable lid with through bores, through which liquid to be purified may be supplied at a top into an interior of the tubular receiving container, a tubular filter insert, which is removably suspended within an inner wall of the tubular receiving container and is sealed with respect to the inner wall of the tubular receiving container by an annular seal and at least one extraction opening for the purified liquid, which extends through the inner wall of the tubular receiving container and/or the base member.

2. A water purification module as claimed in claim 1 wherein the removable lid is screwed with an external screw thread into an internal screw thread on the tubular receiving container.

3. A water purification module as claimed in claim 1 wherein the removable lid is provided with a bayonet fitting.

4. A water purification module as claimed in claim 1 wherein fastened to an upper surface of the removable lid there is a connecting coupling for the liquid to be supplied, which is in communication with the through bores extending obliquely to a lower edge of the removable lid.

5. A water purification module as claimed in claim 1 wherein the filter insert is connected at its upper end to an upper filter holder, which rests on an internal shoulder on the inner wall of the receiving container.

6. A water purification module as claimed in claim 5 wherein a lower end of the tubular filter insert is connected to a lower filter holder.

7. A water purification module as claimed in claim 6 wherein both filter holders include circularly arranged through openings, which are covered by filter sieves.

8. A water purification module as claimed in claim 7 wherein the through openings have an egg shape or a lancet shape.

9. A water purification module as claimed in claim 5 wherein the upper filter holder has a filling opening for the filter material, which is closable by a closure lid and that the removable lid has a central cavity on its underside for receiving the closure lid.

10. A water purification module as claimed in claim 9 wherein a strap may be fastened to the closure lid, with which the tubular filter insert may be lifted out of the receiving container.

11. A water purification module as claimed in claim 1 wherein a venting passage extends through the removable lid, which connects a cavity below the removable lid with the exterior and which is provided with a vent button.

12. A water purification module as claimed in claim 1 wherein the tubular filter insert is refillable or disposable.

13. A water purification module as claimed in claim 1 wherein arranged on a side wall of the tubular receiving container there is a functional block with a connecting coupling for removing purified liquid and a sample extraction valve and further functional elements.
